(19) United States
(12) Patent Application Publication
(10) Pub. No.: US 2003/0167587 A1
(43) Pub. Date: Sep. 11, 2003

(54) Wiper device, especially for motor vehicles

(76) Inventor: Bruno Egner-Walter, Heilbronn (DE)

Correspondence Address: Andrew R Basile, Young & Basile, Suite 624, 3001 West Big Beaver Road, Troy, MI, 48084, US

(21) Appl. No.: 10/344,069

(22) PCT Filed: Aug. 3, 2001
(86) PCT No.: PCT/EP01/09013

(51) Int. Cl. B60S 1/32; B60S 1/38

(52) U.S. Cl. 15/250.43; 15/250.451; 15/250.361

(57) ABSTRACT

The invention relates to a wiper device (1) comprising a wiper arm (2) with a wiper blade (3), which is provided on one end of the wiper arm (2) and which comprises a wiper blade rubber element (4). Said wiper blade rubber element has two longitudinal slots (5), which are situated opposite one another and which extend in a longitudinal direction, and has a supporting element provided in the form of two spring rails (6), which longitudinally extend in a strip-like manner and which are arranged inside the longitudinal slots (3). The inventive wiper device also comprises a joining section (8), which is arranged on the end of the wiper arm (2) facing the wiper blade (3) and which is provided for affixing the wiper blade (3). The invention is characterized in that the ends of the spring rails (6), at least on one end of the wiper blade (3), project in a longitudinal direction over the wiper blade rubber element (4) and they are affixed to the joining section (8). The spring rails (6), in the area of the joining section (8), or the joining section (8) itself comprise(s) spacing means in the area of the joining section. The spacing means specify a defined distance between both spring rail ends (6).

The invention relates to a wiper device, especially for motor vehicles, having a wiper arm, a wiper blade disposed at one end of the wiper arm which comprises a rubber wiping element with two longitudinal grooves arranged opposite each other extending in the longitudinal direction and a load-bearing element in the form of two ribbon-like, elongate flexible splines located in the longitudinal grooves, and with a connecting section disposed at the end of the wiper arm facing toward the wiper blade to affix the wiper blade.

In the aforementioned wiper devices, the load-bearing element ensures optimal distribution of the contact pressure exerted by the wiper arm against the window glass to be wiped. To achieve this, the load-bearing element is suitably pre-bent in its unloaded state, when the wiper blade is not abutting the window glass, and it has a curvature which depends in part on the curvature of the window glass to be wiped. The load-bearing element in the form of two correspondingly pre-bent flexible splines of a wiper device of this kind replaces the complicated yoke construction such as the one known from DE 15 05 357, for example.

A wiper blade of the type described initially is known from DE 196 27 115 A1. A wiper device of this kind has the disadvantage that, particularly because of a connecting device centrally located on the wiper blade, it has a specific structural height which negatively affects the wiping characteristics at high vehicle speeds and can cause wind noise. A further disadvantage of a wiper device of this kind is that because of the positioning of intermediate and end clamps around the spine of the rubber element, there is no relative motion between the rubber wiping element and the flexible splines, as a result of which wiping of window glasses is unsatisfactory, in particular of those which vary in the radius of their curvature.

The object of the present invention is therefore to eliminate the previously enumerated disadvantages of the prior art.

This object is achieved in a wiper device of type described initially, in which the ends of the flexible splines on at least one end of the wiper blade project beyond the rubber wiping element and are affixed to the connecting section, where the ends of the flexible splines have spacing means in the area of the connecting section, or the connecting section has spacing means, which determine a specified distance between the ends of the flexible splines.

By attaching the wiper blade in this way to the wiper arm, no inconvenient affixing apparatus, such as is known from the prior art located in the center of the wiper arm, is required. Moreover, enormous cost benefits result from eliminating this component, particularly in series production. Furthermore, the spacing means ensures that the two flexible splines are located at a specified distance from each other. Particularly when the distance of the two flexible splines from each other is greater than the bridge between the two longitudinal grooves in the rubber element, relative movement of the rubber wiping element with respect to the flexible splines can take place, the movement contributing to good wiping results, particularly when wiping curved window glass.

In accordance with the invention, the spacing means in the two flexible splines can comprise spacing holes arranged opposite each other and at least one spacing clip engaging the spacing holes. The holes are advantageously located in the flexible splines between the rubber wiping element and the end of the wiper arm facing toward the rubber wiping element. A wiper device of this kind has the particular advantage that the two flexible splines sit at a specified distance from each other by reason of the spacing clip even in the pre-assembled state, that is, before they are affixed to the wiper arm. Furthermore, the two flexible splines and the rubber wiping element located between the flexible splines are held together by the spacing clip, so that it is easily possible to transport the wiper blade. It is also conceivable that a spacing clip of this kind with corresponding spacing holes additionally exists on the free end of the wiper blade facing away from the wiper arm.

Advantageous arrangement can be made for the spacing clips to be retained as a snap-fit in the spacing holes This ensures simple assembly of the flexible splines to the rubber wiping element and the spacing clips, while still providing a permanent and non-self-loosening connection.

In another embodiment of the invention, the connecting section of the wiper arm has at least one ridge located centrally as spacing means between the two flexible splines, where the facing sides of the two flexible splines abut the ridge in the assembled state. By reason of a ridge of this kind, a specified distance between the ends of the two flexible splines is pre-established, thereby dispensing with the use of spacing clips. However, the spacing clips described in the preceding can find a use as transportation clips, even in this embodiment of the invention.

A ridge of this nature located on the connecting section can be advantageously and cost-effectively stamped or pressed into the connecting section. It is also conceivable that the connecting section has recesses or slots along which at least the one ridge is formed. Particularly if these slots extend in the longitudinal direction of the wiper blade, defined contact surfaces for the facing longitudinal sides of the flexible splines can be formed by compressing the ridge along these slots.

In a further embodiment of the invention, an insert is provided as a spacing means, which on the one part is located on the connecting section and on the other has a bearing surface to receive the ends of the flexible splines, where the insert comprises at least one projection disposed between the ends of the two flexible splines. An embodiment of the invention of this kind has the advantage that it is not necessary to machine the connecting section to form spacing means. Instead, the insert can be produced separately and positioned between the connecting section and the flexible splines in a subsequent assembly step.

Advantageously the insert can be made of plastic material and the projection is molded onto the insert. An insert of this kind can be produced simply and in a cost-saving manner.

It is further conceivable that the insert has two additional projections gripping the longitudinal sides of the flexible splines away from each other. As a result, the free ends of the flexible splines can be inserted between the centrally located projection and the two laterally located projections, whereby the splines are locked in position relative to each other.

In order to retain the free ends of the two flexible splines to the connecting section in a simple fashion, under the invention the connecting section can fit around or engage the two long sides of the flexible splines and/or of the insert facing away from each other from beneath. Engagement from beneath can be achieved, for example, by bending or staking the connecting section.

It is conceivable in this that the flexible splines have recesses to receive the edges of the connecting section which engage them from beneath. The free ends of the flexible splines are thereby additionally fixed and retained to the connecting section in a simple manner.

It is also conceivable that the flexible splines are retained to the connecting section by a positive fit, an interference fit or by friction. The method that suggests itself in particular is to stake the free ends of the flexible splines to the connecting section. Another, extremely durable and non-loosening type of connection, which has proven to be advantageous in practice, is to weld the free ends of the flexible splines to the connecting section.

In order to allow appropriate relative movement of the rubber wiping element between the two flexible splines in the longitudinal direction, under the invention the width of the projection measured perpendicular to the longitudinal direction of the wiper device is as wide as, or wider than, the bridge between the two longitudinal grooves in the rubber element. In a further embodiment of the invention, a connecting piece to connect the ends of the two flexible splines is furnished on the ends of the flexible splines facing away from the wiper arm. The two free ends of the flexible splines are thereby fixed relative to each other. In addition, the torsional rigidity of the wiper blade can be improved by the use of such a connecting piece.

Additional advantageous embodiments and details of the invention can be found in the description to follow, in which the invention is further described and explained with reference to the embodiments shown in the drawing. In the drawing:

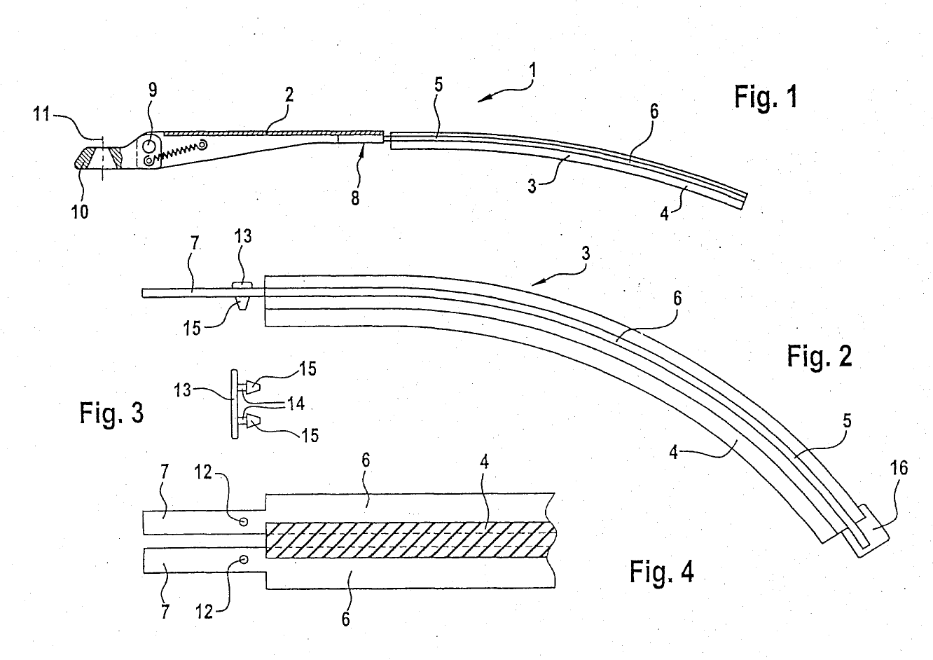

FIG. 1 shows a side view of a wiper device in accordance with the invention,

FIGS. 2, 3 and 4 show details of the wiper device from FIG. 1,

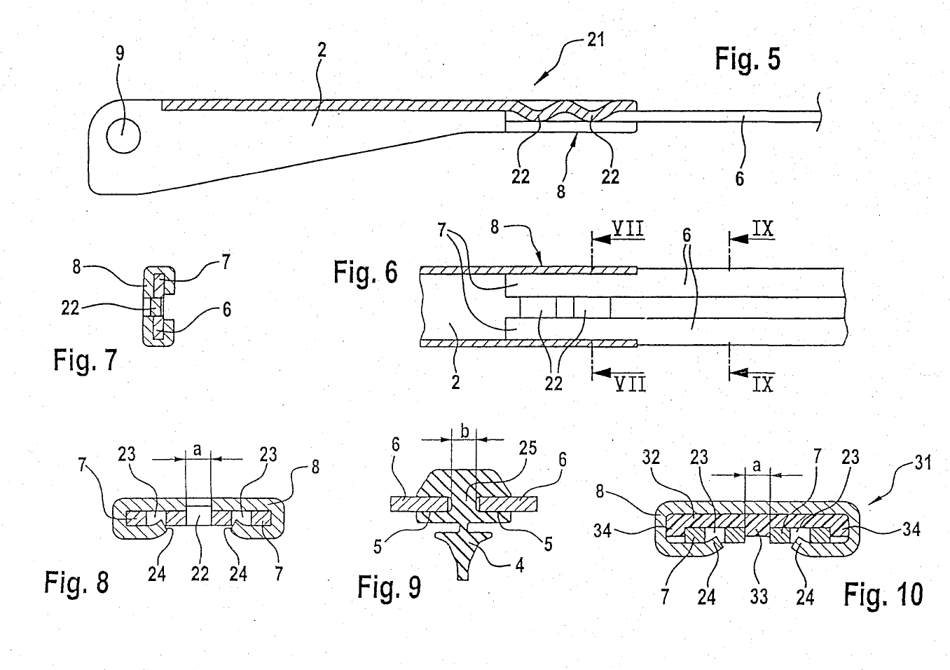

FIGS. 5-9 show another embodiment of the invention in different views,

FIG. 10 shows a further embodiment of the invention in cross section through the connecting section,

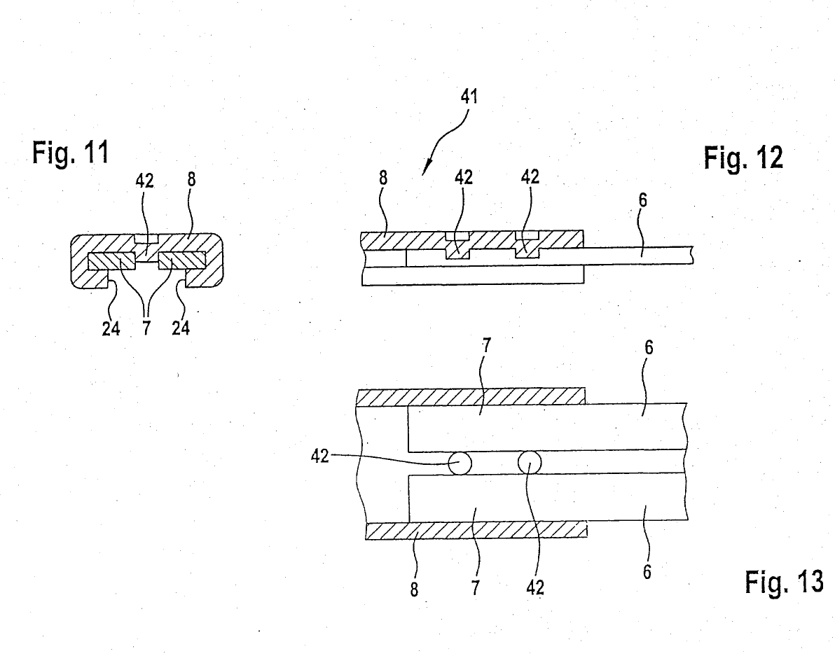

FIGS. 11-13 show a further embodiment of the invention in different views.

FIG. 1 shows a wiper device 1 for motor vehicles with a wiper arm 2 and with a wiper blade 3 located at one end of the wiper arm 2. The wiper blade 3 has a rubber wiping element 4 with two longitudinal grooves 5 arranged opposite each other extending in the longitudinal direction and a load-bearing element in the form of two ribbon-like, elongate flexible splines 6 located in the longitudinal grooves 5. Since the wiper device 1 is shown in the unloaded state, the curvature of the flexible splines 6 can be seen clearly.

As can be clearly seen particularly in FIG. 2, the flexible splines 6 project beyond the rubber wiping element 4 in the longitudinal direction at the end 7 facing toward the wiper arm 2. The projecting ends 7 of the flexible splines 6 are, as shown in FIG. 1, affixed to a connecting section 8 of the wiper arm 2.

The free ends 7 of the flexible splines 6 can be retained to the connecting section 8 by a positive fit, an interference fit or by friction. Staking or welding is particularly recommended.

FIG. 1 additionally shows a driveable component 10 connected through a pivoted connection 9 to the end of the wiper arm 2 facing away from the wiper blade. The driveable component 10 can be driven by a drive device about the axis 11 to create the wiping motion, and a spring acts between the component 10 and the wiper arm 2 to generate a contact pressure of the wiper arm in the direction of the window glass to be wiped.

To maintain a specified distance between the two flexible splines 6, the wiper device 1, in accordance with FIGS. 1-4, furnishes as spacing means in the two flexible splines opposed spacing holes 12 and a spacing clip 13 which can engage the spacing holes 12. The spacing clip 13 shown in FIG. 3 has two pins 14 which are provided to engage the spacing holes 12. Latching means in the form of flexible darts 15 are located at the free ends of the pins 14 which in the assembled state shown in FIG. 2 engage the spacing holes 12 inseparably from beneath.

The spacing clip 31 shown has only two pins 14, each of which engages only one hole 12 in each flexible spline 6. It would be conceivable that the spacing clip 31 can have several pins 14, for example, four or six pins which would be furnished to engage several holes 12.

The advantage of such spacing means is specifically that first of all the two flexible splines 6 are retained at a specified distance to each other. Consequently, when a suitable distance is selected to enable relative movement of the rubber wiping element 4 with respect to the two flexible splines 6, an especially beneficial wiping result can be achieved. Furthermore, the wiper blade 3 is held together by such spacing means as an integral sub-assembly which is easy to handle.

In the embodiment shown in FIG. 4, the flexible splines 6 have a narrower shape at the ends 7 than in the area supporting the rubber wiping element 4. In particular, this allows the connecting section 8 to have smaller dimensions.

As indicated in FIG. 2, a connecting piece 17 is furnished at the ends of the flexible splines 6 facing away from the wiper arm 2, which connecting piece is furnished to connect these two ends of the flexible splines 6.

In the wiper device 21 shown in FIGS. 5-9, the connecting section 8 has two ridges 22 located centrally between the two flexible splines 6 as spacing means. In the assembled state of the wiper device 21, as can be seen particularly clearly in FIG. 6, the facing sides of the flexible splines 6, or rather the ends of the flexible splines 7, abut the side surfaces of the two ridges 22 extending in the longitudinal direction. In order to achieve contact surfaces on the two ridges 22 running parallel to the facing sides of the ends 7 of the flexible splines, the connecting section 8 is first slotted on its upper side on the right and left next to the specific ridge 22. In a subsequent step the ridges are formed by compressing the areas located between the slots. Since the slots run parallel to the long sides of the flexible splines 6, the contact surfaces created also run correspondingly parallel. The wiper device 32 from FIGS. 5-9 has two ridges of this kind. However, it is conceivable that other embodiments, depending on the size and type of the wiper device, can have additional ridges 22.

As is particularly clear from FIG. 7, the connecting section 8 engages the two long sides of the flexible splines 6 facing away from each other from beneath. This is a simple method of achieving secure retention of the flexible splines 6 to the connecting section 8.

FIG. 8 shows a further embodiment of the invention, where FIG. 8 essentially corresponds to the section from FIG. 7. The difference is that the flexible splines 6 have recesses 23 which are there to receive the edges 24 engaging the flexible splines 6 from beneath. This creates an even more stable and durable connection between the flexible splines 6, or the ends 7 of the flexible splines 6, and the connecting section 8 of the wiper arm 2.

To achieve a correspondingly good relative movement of the rubber wiping element 4 in the longitudinal direction of the wiper device 21, the width a measured perpendicular to the longitudinal direction of the wiper device 21 is as wide as, or advantageously a little wider than, the width b of the bridge 25 which is disposed between the two longitudinal grooves 5 of the rubber wiping element 4.

FIG. 10, which shows a cross section through the connecting section 8 of a further wiper device 31, has an insert 32 as spacing means. The insert 32 is located on the connecting section 8 on the one part, and on the other it has a bearing surface to receive the flexible splines 6, or rather the ends 7 of the flexible splines, where the insert has a projection 33 between the two flexible splines. Additionally, the insert 32 has two further projections 34 fitting around the long sides of the flexible splines 7 facing away from each other. This ensures that the insert 32 locates the flexible spline ends 7. To attach the insert 32 and the ends 7 of the flexible splines to the connecting section 8, the connecting section 8 engages the insert 32 as well as the ends 7 of the flexible splines from beneath. In accordance with the embodiment from FIG. 8, the wiper device 31 has recesses 23 to receive the edges 24 engaging the ends 7 of the flexible splines from beneath.

The insert 32 is advantageously made of plastic material, where the projection 33 is molded to the insert.

The wiper device 41 shown in FIGS. 11-13 differs from the wiper device 21 shown in FIGS. 5-9 in that it has projections 42 which have a circular cross section and are stamped into the connecting section 8. As FIG. 11 clearly shows, in accordance with this embodiment as well, the connecting section 8 engages the edges of the two flexible splines facing away from each other from beneath.

All the features represented in the description, the claims to follow and the drawing can be fundamental to the invention individually as well as in any combination with each other.

What is claimed is:

1. Wiper device (1, 21, 31, 41), especially for motor vehicles, having a wiper arm (2), a wiper blade (3) disposed at one end of the wiper arm (2) which comprises a rubber wiping element (4) with two longitudinal grooves (5) arranged opposite each other and extending in the longitudinal direction and a load-bearing element in the form of two ribbon-like, elongate flexible splines (6) located in the longitudinal grooves (5), and having a connecting section (8) located at the end of the wiper arm (2) facing toward the wiper blade (3) to affix the wiper blade (3), characterized in that the ends (7) of the flexible splines (6) on at least one end (7) of the wiper blade (3) protrude beyond the rubber wiping element (4) in the longitudinal direction and are attached to the connecting section (8), where the flexible splines have spacing means in the area of the connecting section (8), or the connection section (8) has spacing means which determine a specified distance (a) between the ends (7) of the two flexible splines.

2. Wiper device (1) from claim 1, wherein the spacing means in the two flexible splines (6) comprise spacing holes (12) arranged opposite each other and at least one spacing clip (13) engaging the spacing holes (12).

3. Wiper device (1) from claim 2, wherein the spacing clip (13) is retained as a snap fit in the spacing holes (12).

4. Wiper device (21, 41) from one of the preceding claims, wherein the connecting section (8) of the wiper arm (2) has at least one ridge (22, 42) centrally positioned between the two ends (7) of the flexible splines as spacing means, where the facing sides of the ends (7) of the flexible splines abut the ridge (22, 42) in the assembled state.

5. Wiper device (41) from claim 3, wherein at least the one ridge (42) is punched or coined into the connecting section (8).

6. Wiper device (21) from claim 3 or 4, wherein the connecting section has recesses or slots, along which at least the one ridge (22) is formed.

7. Wiper device (31) from one of the preceding claims, wherein an insert (32) is furnished as a spacing means, which on the one hand is located on the connecting section (8) and on the other has a bearing surface to receive the ends (7) of the flexible splines, where the insert (32) comprises at least one projection (33) positioned between the two ends (7) of the flexible splines.

8. Wiper device (31) from claim 6, wherein the insert (32) is made of plastic material and the projection (33) is molded onto the insert (32).

9. Wiper device (31) from claim 6 or 7, wherein the insert (32) has two further projections (34) fitting around the long sides of the ends (7) of the flexible splines facing away from each other.

10. Wiper device (1, 21, 31, 41) from one of the preceding claims, wherein the connecting section (8) fits around the two long sides of the ends (7) of the flexible springs facing away from each other and/or the long sides of the insert (32) or engages them from beneath.

11. Wiper device (21, 31) from claim 9, wherein the flexible splines have recesses (23) to receive the edges (24) of the connecting section (8) engaging the flexible splines (6) from beneath.

12. Wiper device (1, 21, 31, 41) from one of the preceding claims, wherein the ends (7) of the flexible splines are retained as a positive fit, an interference fit or by friction to the connecting section (8).

13. Wiper device (1, 21, 31, 41) from one of the preceding claims, wherein the width (a) of the projection measured perpendicular to the longitudinal direction of the wiper device (1, 21, 31, 41) is as wide as, or wider than, the bridge (25, b) between the two longitudinal grooves (5) in the rubber wiping element (4).

14. Wiper device (1, 21, 31, 41) from one of the preceding claims, wherein a connecting piece (16) is furnished on the ends of the flexible splines (6) facing away from the wiper arm (2) to connect the two ends of the flexible splines.
